(19) United States
(12) Patent Application Publication
(10) Pub. No.: US 2026/0360385 A1
(43) Pub. Date: Nov. 12, 2026

(54) CONTROL VINYL

(71) Applicant: ESTEVAN LEAL, WAUKESHA, WI (US)

(72) Inventor: ESTEVAN LEAL, WAUKESHA, WI (US)

(21) Appl. No.: 19/203,532

(22) Filed: May 9, 2025

(51) Int. Cl. G11B 3/00

(52) U.S. Cl. CPC G11B 3/008

(57) ABSTRACT

A selectively illuminated control vinyl for use with a digital vinyl system is disclosed. A portion of the control vinyl serves as a selectively illuminated cue marker for a DJ making music. Selective illumination of a cue marker allows for easy use of the control vinyl in a dark environment such as on a stage performing.

### BACKGROUND OF THE INVENTION

A control vinyl (sometimes called timecode vinyl or timecode record) is a special type of vinyl record that does not contain traditional music tracks. Instead, it contains a timecode signal—a continuous tone or signal encoded on the vinyl, usually in the form of a high-frequency audio signal.

A control vinyl allows DJs (disc jockey) to manipulate digital audio files using traditional turntables by transmitting a timecode signal to DJ software. A control vinyl offers the hands-on feel of vinyl with the vast music access of digital systems for users such as scratch DJs and club performers. A control vinyl is a crucial tool for DJs who use Digital Vinyl Systems (DVS) to blend the traditional tactile feel of vinyl with the flexibility and convenience of digital music libraries.

A signal generated by a control vinyl allows a DVS system (currently commercially available from manufacturers such as Serato DJ, Traktor Scratch, or Rekordbox DVS) to track the movement, speed, direction, and position of the turntable's platter and translate that information to control digital audio files in DJ software.

A typical DVS system includes one or more (commonly two) turntables or CDJs, which is where the control vinyl (or control CD) is played. An audio interface such as a sound card or DVS-Ready mixer connects the turntables to a laptop, and DJ software is then used to route the timecode signals from the control vinyl.

When the DJ plays the control vinyl(s), the stylus (needle) reads the timecode signal, which is then sent through the mixer or audio interface to the DJ software. This timecode signal includes data about speed, direction of spin (forward or reverse) and position (where the needle is on the vinyl). The software then interprets that data to manipulate the playback of a digital audio file in real-time.

With control vinyl, the DJ can “scratch” in the same way pioneering DJs did because the DJ software mimics the position of the needle, so scratching is instant and responsive. The DJ can also cue, which is to place the needle at the beginning of a vinyl track corresponding to the start of the digital track. DJ techniques such as pitch bend/speed up/slow down/spinbacks and tricks can all be used like with traditional vinyl techniques.

In a DJ system, a cue marker—also known as a cue point or a cue sticker—is like a digital bookmark placed on a track. It's a specific moment in the music or position on a control vinyl that a DJ sets so they can instantly return to it at any time. Some DVS systems visually represent cue points or needle drop markers that help DJs know where they are in the song when looking at the control vinyl.

Cue markers are incredibly useful tools for all kinds of DJ techniques such as beatmatching two tracks, setting up a tight transition, looping a section, or preparing a spot to scratch from. Cue points allow a DJ to navigate the music with precision and speed.

### SUMMARY OF THE INVENTION

The present invention relates to an illuminated cue marker, an illuminated cue marker and control vinyl combination, and a control vinyl either internally or externally carrying an illuminated cue marker. In a preferred embodiment, the illumination is either through LED light(s) or a fiber optic extension.

In a preferred embodiment, a control vinyl is provided with an aperture through the center of the control vinyl. On a turntable, the spindle is a central protrusion extending generally vertically and perpendicularly to a platter, which is the spinning surface upon which a record (or in this case a control vinyl) sits. In use, the control vinyl is placed upon the platter and the spindle is placed through the aperture through the control vinyl.

In an additional embodiment, the control vinyl can be equipped with a circuit, preferably an open circuit spanning the aperture of the control vinyl through the control vinyl, and the open circuit becomes a closed circuit when the control vinyl is placed onto the spindle. The open circuit spanning the spindle is completed and closed by placing the control vinyl onto the spindle, with the spindle closing the circuit. As the circuit is completed, the cue marker becomes illuminated. Once the control vinyl is removed from the spindle, the circuit is returned to only a partial circuit and the cue marker is no longer illuminated.

### BRIEF DESCRIPTION OF DRAWINGS

FIG. 1 is a top schematic view of a digital vinyl system (DVS);

FIG. 2 is a top view of a control vinyl carrying an illumination section;

FIG. 3 is a top view thereof, with the illumination section illuminated;

FIG. 4 is a bottom view thereof;

FIG. 5 is a top view of an alternate embodiment of a control vinyl, with the control vinyl carrying an incomplete electrical circuit;

FIG. 6 is a top view thereof, with a turntable spindle completing the circuit and enabling illumination.

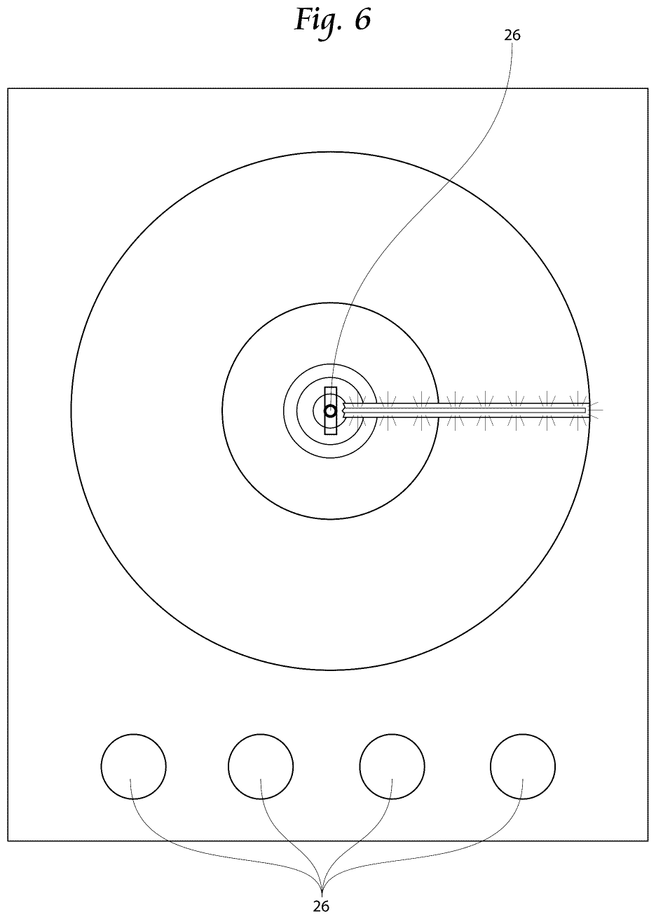

### DETAILED DESCRIPTION OF THE INVENTION

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

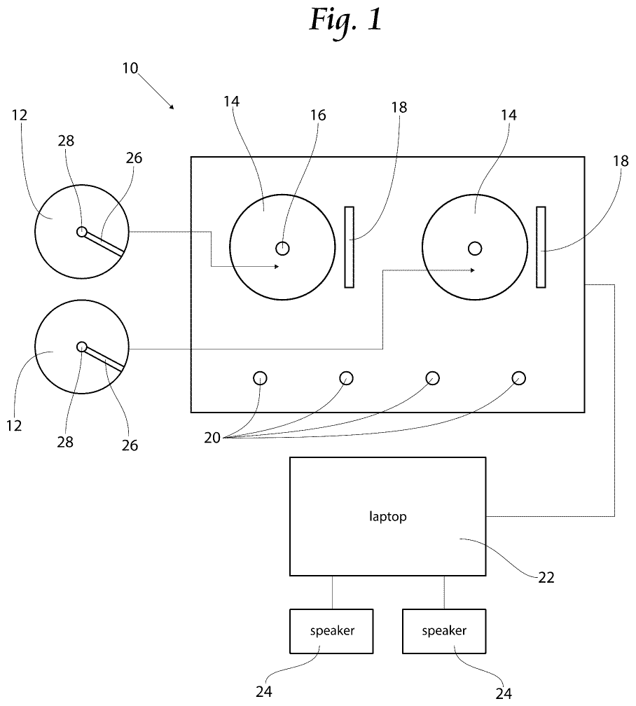

Referring now to FIG. 1, a top schematic view of a digital vinyl system (DVS) 10 is shown. In this simplified representation, a turntable platter 14 and preferably a pair of them—carry a control vinyl 12. Particularly, a preferably metallic spindle 16 carried by turntable platter 14 fits through a spindle hole 28 on control vinyl 12. Tone arm/cartridge/needle 18 and a variety of controls 20 are provided as part of the system 10. A signal is generated by reading the control vinyl(s) 12 and sent to a processor such as a laptop computer 22, which processes the signals and generates output to one or more speakers 24.

The control vinyl 12 bears a time-coded signal that a sound card within the system can read and translate downstream for further processing and audio output (not shown).

A cue marker (aka cue point) 26 is carried by control vinyl 12 and is used by the DJ as described above.

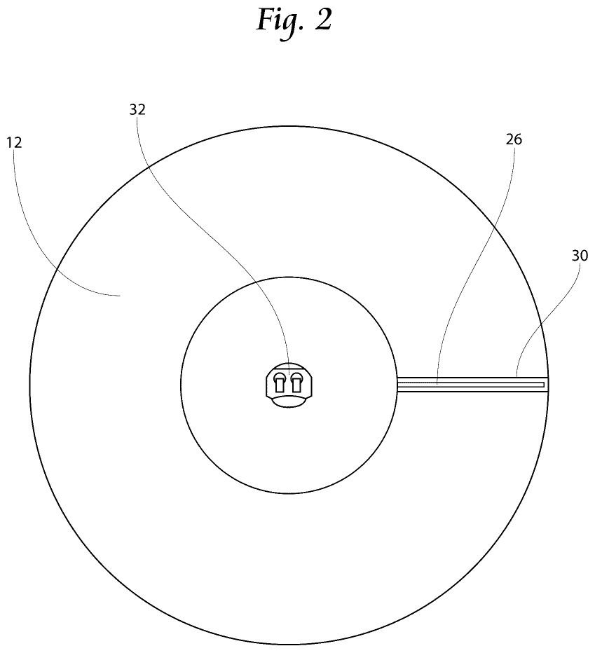

Referring now to FIG. 2, a top view of control vinyl 12 carrying a cue marker coupling 30 is shown. In the illustrated embodiment, control vinyl 12 carries a cue marker 26 that is selectively illuminated.

Cue marker coupling 30 can comprise a bore or channel through a solid piece of vinyl, and/or can comprise an anchor (such as adhesive) for lights such as an array of LED lights to be carried externally to control vinyl 12. Alternatively, control vinyl 12 can comprise a stratified construction with selectively illuminated cue marker 26 carried between layers such that cue marker coupling 30 can comprise an channel carrying selectively illuminated cue marker 26 therein. Other embodiments are possible.

Power source/power control 32 can be coupled with the lights of selectively illuminated cue marker 26 to power and turn illumination on/off.

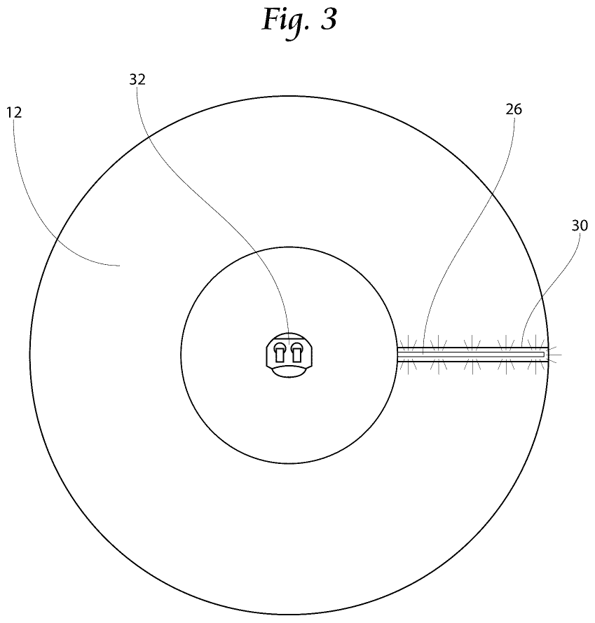

Referring now to FIG. 3 a top view thereof is shown, with selectively illuminated cue marker 26 illuminated. Power has been supplied to one or more lights in a selected pattern, such as a line (shown). Other patterns such as signals, logos, dots, words, shapes, etc. are variants dictated by user preference.

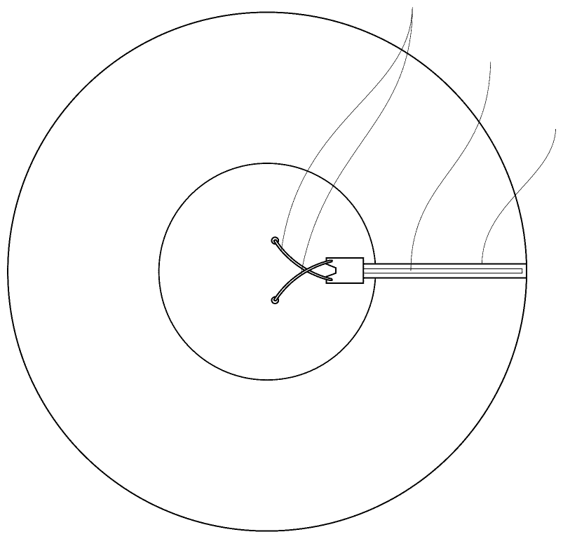

Referring now to FIG. 4 a bottom view thereof is shown, with positive/negative leads 34 shown.

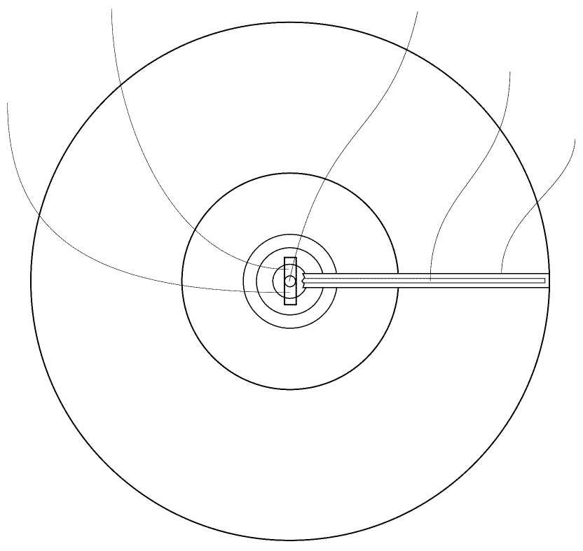

FIG. 5 a top view of an alternate embodiment of a control vinyl 12 with the control vinyl 12 carrying electrical contacts 36 is shown. A power source such as a small battery can be provided (not shown) in order to power one or more lights of the selectively illuminated cue marker 26.

As shown, electrical contacts 36 comprise an incomplete electrical circuit. However, as shown in FIG. 7 which is a top view of control vinyl 12 with spindle 16 of turntable platter 14 (see FIG. 1) placed through a corresponding spindle hole 28 of control vinyl 12. Spindle 16 of the turntable platter 14 completes the circuit between electrical contacts 36 (preferably an electrically conductive material), enabling illumination. This configuration allows for control vinyl 12 to use spindle 16 of the turntable platter 14 like an on/off switch, because placement of control vinyl 12 and spindle hole 28 about spindle 16 of the turntable platter 14 automatically turns selectively illuminated cue marker 26 on/off. When the circuit between electrical contacts 36 and spindle 16 is closed (complete path), electrons flow from the negative terminal of the power source (battery), through the load, and back to the positive terminal—powering the light(s) of selectively illuminated cue marker 26. If the circuit is open (broken path), no current flows, and nothing happens.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

1. A control vinyl comprising:
a disc comprising a spindle hole;
a timecode signal carried by said disc;
a source of light carried by said disc, said source of light selectively illuminating a cue marker portion of said disc.

2. The control vinyl of claim 1, said control vinyl further comprising an electrically conductive material carried by said disc at a first location abutting said spindle hole and at a second location abutting said spindle hole.

3. The control vinyl of claim 1, said control vinyl carried by a turntable platter of a digital vinyl system.

4. The control vinyl of claim 1, said cue marker portion of said disc comprising a radially extending light.

5. The control vinyl of claim 1, said radially extending light comprising an array of lights extending from said spindle hole to an edge of said disc.

6. A pair of control vinyls according to claim 1 carried by a pair of turntable platters of a digital vinyl system.

7. The control vinyl of claim 1, said disc comprising a top surface and a bottom surface, said source of light carried between said top surface and said bottom surface.

8. The control vinyl of claim 1, said disc comprising a top surface and a bottom surface, said source of light carried by at least one of said top surface and said bottom surface.

9. The control vinyl of claim 1, said source of light carried by a channel formed in said disc.
